(19) United States
(12) Patent Application Publication
(10) Pub. No.: US 2019/0079995 A1
(43) Pub. Date: Mar. 14, 2019

(54) Method, System, Server and User Terminal for Displaying User Comment Data

(71) Applicant: Guangzhou Shenma Mobile Information Technology Co., Ltd., Guangzhou (CN)

(72) Inventors: Shiting Jin, Guangzhou (CN); Yin Zhen, Guangzhou (CN); Qiuhui Li, Guangzhou (CN); Dong Niu, Guangzhou (CN)

(73) Assignee: Guangzhou Shenma Mobile Information Technology Co., Ltd., Guangzhou (CN)

(21) Appl. No.: 16/085,477

(22) PCT Filed: Apr. 13, 2017
(86) PCT No.: PCT/CN2017/080420

§ 371 Date: Sep. 14, 2018

(30) Foreign Application Priority Data
Sep. 9, 2016 (CN) 201610815103.2

(51) Int. Cl. G06F 17/30; H04L 29/08

(52) U.S. Cl. CPC G06F 17/30625; H04L 67/327; G06F 17/30867; G06F 17/30699

(57) ABSTRACT

Embodiments of the present application provide a method, a system, a server and a user terminal for displaying comment data of a user. The user has a user identifier. The comment data comprises self-owned comment data. The user identifier has an associated self-owned comment array object. The self-owned comment array object comprises storage tree node information. The self-owned comment data is stored in the storage tree node information. The method comprises: receiving a self-owned comment viewing request sent by a client, a user identifier being included in the self-owned comment viewing request; extracting storage tree node information of a self-owned comment array object associated with the user identifier; feeding back to the client the self-owned comment data in the storage tree node information, such that the self-owned comment data in the storage tree node information is displayed on the client. Applying the embodiments of the present application, loading can be completed very quickly, improving the search efficiency for comment data of a user, and improving user experience.

This application is a US national phase application under 35 U.S.C. § 371 of PCT Application PCT/CN2017/080420, titled Method, System, Server, and User Terminal for Displaying User Comment Data and filed on Apr. 13, 2017, which claims priority to Chinese Patent Application No. 201610815103.2, entitled Method, System, Server and Client for Displaying User Comment Data, submitted to the Chinese Patent Office on Sep. 9, 2016, the content of both applications being incorporated herein by reference in their entirety.

### TECHNICAL FIELD

Embodiments of the present invention relate to the field of Internet technologies, and, more particularly, to a method for storing comment data of a user, a method for storing comment data of a user, a system for storing comment data of a user, and a system for processing comment data of a user, a server and a user terminal.

### BACKGROUND

With the development of the internet, the importance of information flow content has been increasingly recognized. Today Headlines, UC Headlines, NETEASE news and other information flow products came into existence suddenly, and the emergence of various self-publishing media platforms has greatly improved the diversity and interest of information flow products. Comment content, as an indispensable part of the information flow product, greatly enhances the interaction between the original author and the readers as well as the interaction among the readers. Users often attach great importance to their comments' being replied, but there are still some problems with the existing products on the market.

Referring to FIG. 1, a schematic diagram of displaying comment data of a user in the prior art is shown. Currently, most websites display responses to a comment in the form of a “thread”. This form of displaying is a waste of visual space. If a user wishes to view the latest comments, he or she often has to scroll down to the last one, which would be very inefficient when there are over 10 comments in succession. If there are multiple users replying to the same user in the middle of a comment thread, there will be multiple duplicate threads of posts, and this makes no sense. In particular, the existing comment displaying methods have the following drawbacks:

1) when a comment of a user is replied to by other users, the user is often most concerned about who replied to his/her comment, and whose comment is replied to by him/her. The above-mentioned thread form would have the target user's comment flooded by a large number of comments, so that the user cannot locate the context position of the reply to his/her own comment in the first time.

2) when performing unified management to the user's own comments, it is not only necessary to perform centralized display of all the self-owned comments of the current user, but also necessary to reflect the contextual comments to which each comment replies—which will also be very complicated if the displaying is not good enough.

3) each comment may have different importance to the user. Some comment may be more popular and may have more replies, and the user may wish to go into the context of that comment for in-depth viewing and reply again.

4) the user may reply to multiple articles, and also may reply again to other users' comments, or may reply to those replies to the user's self-owned comments, and therefore the hierarchy would be quite complicated, making it very difficult for storage and displaying to be efficient, complete, flexible and hierarchically.

### SUMMARY

An embodiment of the present application provides a method for storing comment data of a user, a method for storing comment data of a user, a system for storing comment data of a user, a system for processing comment data of a user, a server and a user terminal, used for solving drawbacks of the comment data displaying of the prior art.

In order to solve the above problem, the present application discloses a method for displaying comment data of a user, the user has a user identifier, the comment data comprises self-owned comment data, the user identifier has an associated self-owned comment array object, the self-owned comment array object comprises storage tree node information, and the self-owned comment data is stored in the storage tree node information,

The method comprises:

Receiving a self-owned comment viewing request sent by a client, a user identifier being included in the self-owned comment viewing request;

Extracting storage tree node information of a self-owned comment array object associated with the user identifier; and

Feeding back to the client the self-owned comment data in the storage tree node information, such that the self-owned comment data in the storage tree node information is displayed on the client.

Preferably, the comment data further comprises associated comment data associated with the self-owned comment data, the storage tree node information comprises node location information corresponding to a storage tree node of a storage tree where the self-owned comment data is located. The method further comprises, after the step of feeding back to the client the self-owned comment data in the storage tree node information such that the self-owned comment data in the storage tree node information is displayed on the client:

Receiving an associated comment viewing request sent by the client, the associated comment viewing request comprises the node location information of the self-owned comment data;

Determining a storage tree node of the self-owned comment data using the node location information;

Obtaining an associated storage tree node of the storage tree node in a storage tree, the associated comment data being stored in the associated storage tree node;

Feeding back to the client the associated comment data of the associated storage tree node.

Preferably, the storage tree node includes associated node location information, and the step of obtaining an associated storage tree node of the storage tree node in the storage tree comprises:

Determining the associated storage tree node of the storage tree node in the storage tree using the associated node location information.

Preferably, the comment data comprises: comment text, a total number of reply comment data for the comment data, a number of upvotes for the comment data, a number of downvotes for the comment data, whether the comment data is hot comment data, and creation time of the comment data.

An embodiment of the present application further discloses a method for storing comment data of a user, comprising:

Obtaining comment data of a user under media data, the comment data has a user identifier;

Generating storage tree node information using the comment data and the user identifier; and

Storing the storage tree node information as a self-owned comment array object according to the user identifier.

Preferably, the step of generating storage tree node information using the comment data and the user identifier comprises:

Determining a storage tree corresponding to the media data;

Generating a storage tree node in the storage tree according to the comment data;

Storing the comment data and the user identifier in the storage tree node;

Generating storage tree node information according to the storage tree node.

Preferably, the step of determining a storage tree corresponding to the media data comprises:

Determining whether there is a storage tree corresponding to the media data;

If so, performing the step of generating a storage tree node in the storage tree according to the comment data;

If not, creating a root storage tree node to generate a storage tree.

Preferably, the step of generating storage tree node information according to the storage tree node comprises:

Determining node location information of the storage tree node in the storage tree, and an associated storage tree node of the storage tree node in the storage tree; and

Storing the comment data, the user identifier and the node location information in a storage tree node.

Preferably, the comment data comprises self-owned comment data, and the step of storing the storage tree node information as a self-owned comment array object according to the user identifier comprises:

Filtering out the storage tree node information corresponding to the user identifier, the storage tree node information comprises self-owned comment data;

Determining the self-owned comment array object using the user identifier;

Storing the storage tree node information in the self-owned comment array object.

Preferably, the self-owned comment data in the storage tree node information includes a creation time, and the step of storing the storage tree node information in the self-owned comment array object is:

To store the storage tree node information in the self-owned comment array object sequentially according to the creation time.

An embodiment of the present application further discloses a system for displaying comment data of a user, the user has a user identifier, the comment data comprises self-owned comment data, the user identifier has an associated self-owned comment array object, the self-owned comment array object comprises storage tree node information, and the self-owned comment data is stored in the storage tree node information,

The system comprises:

A self-owned comment viewing request receiving module, configured to receive a self-owned comment viewing request sent by a client, a user identifier being included in the self-owned comment viewing request;

A storage tree node information extracting module, configured to extract storage tree node information of a self-owned comment array object associated with the user identifier; and

A comment data displaying module, configured to feedback, to the client, the self-owned comment data in the storage tree node information, such that the self-owned comment data in the storage tree node information is displayed on the client.

Preferably, the comment data further comprises associated comment data associated with the self-owned comment data, the storage tree node information comprises node location information corresponding to a storage tree node of a storage tree where the self-owned comment data is located,

The system further comprises:

An associated comment viewing request receiving module, configured to receive an associated comment viewing request sent by the client, the associated comment viewing request comprises the node location information of the self-owned comment data;

A storage tree node determining module, configured to determine a storage tree node of the self-owned comment data using the node location information;

An associated storage tree node obtaining module, configured to obtain an associated storage tree node of the storage tree node in a storage tree, the associated comment data being stored in the associated storage tree node; and

An associated comment data feedback module, configured to feedback to the client the associated comment data of the associated storage tree node.

Preferably, the storage tree node includes associated node location information, and the associated storage tree node obtaining module comprises:

An associated storage tree node determining submodule, configured to determine the associated storage tree node of the storage tree node in the storage tree using the associated node location information.

An embodiment of the present application further discloses a system for storing comment data of a user, comprising:

A comment data obtaining module, configured to obtain self-owned comment data of a user under media data, the comment data has a user identifier;

A storage tree node information generating module, configured to generate storage tree node information using the comment data and the user identifier; and

A self-owned comment array object storage module, configured to store the storage tree node information as a self-owned comment array object according to the user identifier.

Preferably, the storage tree node information generating module comprises:

A storage tree determining submodule, configured to determine a storage tree corresponding to the media data;

A storage tree node generating submodule, configured to generate a storage tree node in the storage tree according to the comment data;

A comment data storage submodule, configured to store the comment data and the user identifier in the storage tree node;

A storage tree node information generating submodule, configured to generate storage tree node information according to the storage tree node.

Preferably, the storage tree determining submodule comprises:

A storage tree determining unit, configured to determine whether there is a storage tree corresponding to the media data; if so, the storage tree node generating submodule is invoked, and if not, a storage tree creating unit is invoked; and

The storage tree creating unit, configured to create a root storage tree node to generate a storage tree.

Preferably, the storage tree node information generating submodule comprises:

A node location information determining unit, configured to determine node location information of the storage tree node in the storage tree, and an associated storage tree node of the storage tree node in the storage tree;

A storage tree node information organizing unit, configured to store the comment data, the user identifier and the node location information in a storage tree node.

Preferably, the self-owned comment array object storage module comprises:

A storage tree node information filtering submodule, configured to filter out the storage tree node information corresponding to the user identifier, the storage tree node information comprises self-owned comment data;

A self-owned comment array object determining submodule, configured to determine the self-owned comment array object using a user identifier of the storage tree node information;

A storage tree node information storage submodule, configured to store the storage tree node information in the self-owned comment array object.

Preferably, the self-owned comment data in the storage tree node information includes a creation time, and the storage tree node information storage submodule comprises:

A storage tree node information storage unit, configured to store the storage tree node information in the self-owned comment array object sequentially according to the creation time.

An embodiment of the present application further discloses a server, wherein the user has a user identifier, the comment data comprises self-owned comment data, the user identifier has an associated self-owned comment array object, the self-owned comment array object comprises storage tree node information, and the comment data is stored in the storage tree node information,

The server comprises a memory and a processor, the memory stores means for displaying the comment data of the user, the means for displaying the comment data of the user comprises one or more software function modules executed by the processor, and the means for displaying the comment data of the user comprises:

A self-owned comment viewing request receiving module, configured to receive a self-owned comment viewing request sent by a client, a user identifier being included in the self-owned comment viewing request;

A storage tree node information extracting module, configured to extract storage tree node information of a self-owned comment array object associated with the user identifier; and

A self-owned comment data displaying module, configured to feedback, to the client, the self-owned comment data in the storage tree node information, such that the self-owned comment data in the storage tree node information is displayed on the client.

An embodiment of the present application further discloses a server, comprising a memory and a processor, wherein the memory stores means for storing comment data of a user, the means for storing comment data of a user comprising one or more software function modules executed by the processor, the means for storing comment data of a user includes:

A comment data obtaining module, configured to obtain comment data of the user under media data, the comment data has a user identifier;

A storage tree node information generating module, configured to generate storage tree node information using the comment data and the user identifier;

A self-owned comment array object storage module, configured to store the storage tree node information as a self-owned comment array object according to the user identifier.

An embodiment of the present application further discloses a method for displaying comment data of a user, wherein the comment data comprises self-owned comment data, the method comprising:

Sending to the server a self-owned comment viewing request, a user identifier being included in the self-owned comment viewing request;

Receiving self-owned comment data in the storage tree node information fed-back by the server for the self-owned comment viewing request; wherein the user identifier has an associated self-owned comment array object, the self-owned comment array object comprises storage tree node information, and the self-owned comment data is stored in the storage tree node information; and

Displaying the self-owned comment data.

Preferably, the self-owned comment data includes a creation time, and the step of displaying the self-owned comment data comprises:

Obtaining a comment reply box template, the comment reply box template including a comment box;

Adding the self-owned comment data to the comment box sequentially according to the creation time; and

Displaying the self-owned comment data based on the comment reply box template.

Preferably, the self-owned comment data is located under a certain media data, the step of adding the self-owned comment data to the comment box sequentially according to the creation time comprises:

Grouping the self-owned comment data according to the media data where it is located;

For the grouped self-owned comment data, adding the self-owned comment data of the same group to the comment box sequentially according to the creation time.

Preferably, the self-owned comment data further comprises: a self-owned comment text, a total number of reply comment data for the self-owned comment data, a number of upvotes for the comment data, a number of downvotes for the self-owned comment data, whether the self-owned comment data is hot comment data.

Preferably, the comment data further comprises associated comment data associated with the self-owned comment data, the method further comprising:

Sending an associated comment viewing request to the server, the associated comment viewing request including node location information of the self-owned comment data;

Receiving associated comment data of the associated storage tree node fed-back by the server for the associated comment viewing request; wherein the server is configured to determine the storage tree node of the self-owned comment data using the node location information, and obtain an associated storage tree node of the storage tree node in the storage tree; and

Displaying the associated comment data.

Preferably, the storage tree node has a sibling node, a parent node and a child node in the storage tree, and the sibling node, the parent node and the child node are associated storage nodes of the a storage tree.

An embodiment of the present application further discloses a system for displaying comment data of a user, wherein the comment data comprises self-owned comment data, the system comprising:

A self-owned comment viewing request sending module, configured to send a self-owned comment viewing request to a server, a user identifier being included in the self-owned comment viewing request;

A self-owned comment data receiving module, configured to receive self-owned comment data in the storage tree node information fed-back by the server for the self-owned comment viewing request; wherein the user identifier has an associated self-owned comment array object, the self-owned comment array object comprises storage tree node information, and the self-owned comment data is stored in the storage tree node information; and

A self-owned comment data displaying module, configured for displaying the self-owned comment data.

Preferably, the self-owned comment data includes a creation time, and the self-owned comment data displaying module comprises:

A comment reply box template obtaining submodule, configured to obtain a comment reply box template, the comment reply box template includes a comment box;

A self-owned comment data adding submodule, configured to add the self-owned comment data to the comment box sequentially according to the creation time;

A self-owned comment data template displaying submodule, configured to display the self-owned comment data based on the comment reply box template.

Preferably, the self-owned comment data belongs under a certain media data, and the self-owned comment data adding submodule comprises:

A self-owned comment data grouping unit, configured to group the self-owned comment data according to the media data to which it belongs;

A self-owned comment data adding-by-group unit configured to, for the grouped self-owned comment data, add the self-owned comment data of the same group to the comment box sequentially according to the creation time.

Preferably, the comment data further comprises associated comment data associated with the self-owned comment data, the system further comprising:

An associated comment viewing request sending module, configured to send an associated comment viewing request to the server, the associated comment viewing request including node location information of the self-owned comment data;

An associated comment data receiving module, configured to receive associated comment data of the associated storage tree node fed-back by the server for the associated comment viewing request; wherein the server is configured to determine the storage tree node of the self-owned comment data using the node location information, and obtain an associated storage tree node of the storage tree node in the storage tree;

An associated self-owned comment data displaying module, configured for displaying the associated comment data.

An embodiment of the present application further discloses a user terminal, wherein the comment data comprises self-owned comment data, the user terminal comprises a memory and a processor, the memory stores means for displaying the comment data of the user, the means for displaying the comment data of the user comprises one or more software function modules executed by the processor, and the means for displaying the comment data of the user comprises:

A self-owned comment viewing request sending module, configured to send to the server a self-owned comment viewing request, a user identifier being included in the self-owned comment viewing request;

A self-owned comment data receiving module, configured to receive self-owned comment data in the storage tree node information fed-back by the server for the self-owned comment viewing request; wherein the user identifier has an associated self-owned comment array object, the self-owned comment array object comprises storage tree node information, and the self-owned comment data is stored in the storage tree node information; and

A self-owned comment displaying module, configured to display the self-owned comment data.

An embodiment of the present application further discloses a computer storage medium configured for storing computer software instructions used by the means for displaying comment data of a user, which instructions include a program designed for executing the means for displaying comment data of a user.

An embodiment of the present application further discloses a computer storage medium configured for storing computer software instructions used by the means for storing comment data of a user, which instructions include a program designed for executing the means for storing comment data of a user.

An embodiment of the present application further discloses a computer storage medium configured for storing computer software instructions used by the means for displaying comment data of a user, which instructions include a program designed for executing the means for displaying comment data of a user.

Embodiments of the present application include the following advantages:

The comment data of the user in the embodiment of the present application is pre-stored in the self-owned array object associated with the user, wherein the self-owned comment array object includes the storage tree node information which stores the user's self-owned comment data. When a client wants to view the self-owned comment data, a corresponding self-owned comment array object can be obtained according to the user identifier, and the corresponding storage tree node information is extracted according to the self-owned comment array object, so that the self-owned comment data in the storage tree node information can be quickly provided to the client. In an embodiment of the present application, there is a self-owned comment array object maintained under each user, therefore, when accessing self-owned comment data of a certain user, the loading can be completed very quickly, thereby enhancing the search efficiency of the comment data of the user and improving user experience. In addition, in an embodiment of the present application, storage tree node information will be generated in sequential order using the user's comment data under media data. Meanwhile, the storage tree node information is also used to maintain self-owned comment array object of the corresponding user according to the user identifier. Such storage tree structure can have the user's comment data saved in a clear hierarchy, so that the user can find the desired comment data efficiently, completely, flexibly and hierarchically.

### BRIEF DESCRIPTION OF THE DRAWINGS

FIG. 1 is a schematic diagram of displaying comment data of a user in the prior art;

FIG. 2 is a flow chart of steps of embodiment 1 of a method for displaying comment data of a user according to the present application;

FIG. 3 is a flow chart of steps of an embodiment of a method for storing comment data of a user according to the present application;

FIG. 4 is a flow chart of steps of embodiment 2 of a method for displaying comment data of a user according to the present application;

FIG. 5 is a schematic diagram of a storage structure of a user comment data storage tree of the present application;

FIG. 6 is a schematic diagram of a displaying operation of a comment data reply box of a user on a client of the present application;

FIG. 7 is a structural block diagram of embodiment 1 of a system for displaying comment data of a user of the present application;

FIG. 8 is a structural block diagram of an embodiment of a system for storing comment data of a user of the present application;

FIG. 9 is a structural block diagram of embodiment 2 of a system for displaying comment data of a user of the present application;

FIG. 10 is a structural block diagram of means for displaying comment data of a user in a server of the present application;

FIG. 11 is a structural block diagram of means for storing comment data of a user in another server of the present application;

FIG. 12 is a structural block diagram of means for displaying comment data of a user in a user terminal according to the present application.

FIG. 13 is a structural block diagram of an embodiment of a server of the present application.

FIG. 14 is a structural block diagram of an embodiment of a user terminal of the present application.

### DETAILED DESCRIPTION

The abovementioned objects, features and advantages of the present application will become more apparent in view of the following detailed description of the present application with reference to the accompanying drawings and specific embodiments.

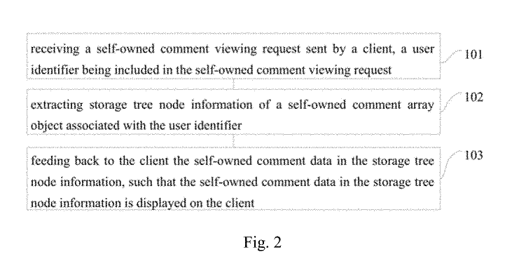

Referring to FIG. 2, a flow chart of steps of a method for displaying comment data of a user according to the present application is shown.

In a specific implementation, a user may have a user identifier, and the comment data comprises self-owned comment data. The so-called self-owned comment data refers to comment data of a certain specific user, for example, data of comment of a user “a” under article a and article b.

In an embodiment of the present application, an associated self-owned comment array object may be maintained according to the user identifier, the self-owned comment array object may include storage tree node information, and the self-owned comment data may be stored in the storage tree node information. That is to say, the embodiment of the present application maintains for each user a set of self-owned comment array objects storing their self-owned comment data.

Specifically, the user identifier may include a user account, a user address and the like, and the user identifier can identify a specific user. When a user logs in on a certain client, he or she may obtain the user account used for logging in as his or her user identifier.

Embodiments of the present application can be applied to various mobile devices, for example, mobile phones, tablet computers, personal digital assistants, wearable devices (such as glasses, watches, etc.), and the like, and can also be applied to various fixed devices, for example, smart televisions, personal computers, etc.

The operating systems of these mobile and fixed devices may include android, ios, windows phone, windows, etc., in which various clients, such as browsers, can be installed to display user comments under media data. In an embodiment of the present application, interaction with the server may be performed via the client, so that the user on the client can obtain comment data of the user stored on the server.

In particular, the method may include the following steps:

Step 101: receiving a self-owned comment viewing request sent by a client, a user identifier being included in the self-owned comment viewing request;

In the embodiment of the present application, the server maintains, for each user, his or her associated self-owned comment array object, and the self-owned comment array object includes the storage tree node information of the user, and the storage tree node information includes the user's self-owned comment data.

If a user on a client wants to view the self-owned comment data, he or she may click on a button or a component on the client to view the self-owned comment data, then a self-owned comment viewing request carrying the user identifier will be generated and sent to the server, so as to request the server to find the user's self-owned comment data or other comment data associated with the self-owned comment data.

Step 102: extracting storage tree node information of a self-owned comment array object associated with the user identifier;

After the server receives the self-owned comment viewing request, the server obtains a maintained self-owned comment array object corresponding to the user identifier in the self-owned comment viewing request, the storage tree node information being included in the comment array object.

Step 103: feeding back, to the client, the self-owned comment data in the storage tree node information, such that the self-owned comment data in the storage tree node information is displayed on the client.

In a specific application, after the server obtains the storage tree node information, the server sends the storage tree node information to the client, and the client may extract the user's self-owned comment data according to the storage tree node information, so as to display the self-owned comment data to the user.

In general, the server can feedback to the client all the self-owned comment array objects managed by the user identifier, and then the client extracts the required data from the self-owned comment array objects. Of course, the server can extract required data from the self-owned comment array object, and send it to the client. These procedures may be taken according to the actual needs.

In a preferred embodiment of the present application, the comment data further comprises associated comment data associated with the self-owned comment data, the storage tree node information may comprise node location information corresponding to a storage tree node of a storage tree where the self-owned comment data is located. After the step 103, the following step may be further included:

Receiving an associated comment viewing request sent by the client, the associated comment viewing request comprises the node location information of the self-owned comment data;

Determining a storage tree node of the self-owned comment data using the node location information;

Obtaining an associated storage tree node of the storage tree node in a storage tree, the associated comment data being stored in the associated storage tree node; and

Feeding back to the client the associated comment data of the associated storage tree node.

In a specific implementation, the storage tree node information is stored in a corresponding storage tree node of the storage tree, and the storage tree further includes other storage tree nodes. Here, the other nodes (e.g. Sibling nodes of the same level, parent nodes or child nodes) in the storage tree in connection with the storage tree node may be referred to as associated storage tree nodes of the storage tree node, and the associated storage tree nodes store associated comment data that is associated with the comment data in the storage tree node. For example, it may be the previous or next comment data of the self-owned comment data.

In a preferred embodiment of the present application, the storage tree node may include associated node location information, and the step of obtaining an associated storage tree node of the storage tree node in the storage tree may comprise:

Determining the associated storage tree node of the storage tree node in the storage tree using the associated node location information.

If the user wants to view other associated comment data of a certain self-owned comment data, he or she may click the self-owned comment data on the client, to generate an associated comment viewing request for the self-owned comment data to send to the server, wherein the associated comment viewing request include associated node location information.

The server may locate the corresponding storage tree and corresponding storage tree nodes in the storage tree according to the node location information, where associated node location information is included in the storage tree node. The associated node location information may be used to locate an associated storage tree node in the storage tree, and then the associated comment data in the associated storage tree node information is extracted from the associated node location information, and then the associated comment data is fed-back to the client.

The user of the embodiment of the present application can obtain the associated comment data of the self-owned comment data. In this way, the self-owned comment data can be expanded to trace the topic of interest, and further expansion may be made on the basis of a previous expansion. Accordingly, with respect to an interested topic, one can inquire into the root of the matter.

The comment data of the user in the embodiment of the present application is pre-stored in the self-owned array object associated with the user, wherein the self-owned comment array object includes the storage tree node information which stores the user's self-owned comment data. When a client wants to view the self-owned comment data, a corresponding self-owned comment array object can be obtained according to the user identifier, and the corresponding storage tree node information is extracted according to the self-owned comment array object, so that the self-owned comment data in the storage tree node information can be quickly provided to the client. In an embodiment of the present application, there is a self-owned comment array object maintained under each user, therefore, when accessing self-owned comment data of a certain user, the loading can be completed very quickly, thereby enhancing the search efficiency of the comment data of the user and improving user experience.

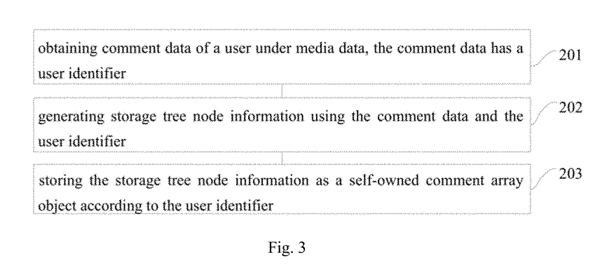

In referring to FIG. 3, a flow chart of steps of a method for storing comment data of a user of the present application is shown. In particular, the method may include the following steps:

Step 201: obtaining comment data of a user under media data, the comment data has a user identifier;

In a specific implementation, the media data may refer to articles under Today's Headlines, UC Headlines, NetEase news, etc., under which the user can make comments, thereby generating comment data under the article.

It should be noted that the comment data may carry the user identifier. If the user makes comments after logging in, the user account may be used as the user identifier. If the user makes comments without logging in, then the user's login address may be obtained as the user identifier.

Step 202: generating storage tree node information using the comment data and the user identifier;

In embodiments of the present application, each media data has a corresponding storage tree for storing comment data of all users under the media data. When a user makes a comment under the media data, storage tree node information is generated according to the comment data and the user identifier, and is then saved in the storage tree.

In a preferred embodiment of the present application, the step 202 may include the following sub-steps:

Sub-step s11, determining a storage tree corresponding to the media data;

In a preferred embodiment of the present application, the sub-step s11 may include the following sub-steps:

Sub-step s11-1, determining whether there is a storage tree corresponding to the media data; if so, sub-step s12 is performed, and if not, sub-step s11-2 is performed;

Sub-step s11-2, creating a root storage tree node to generate a storage tree.

In the embodiment of the present application, it is first determined whether there is a storage tree corresponding to the media data. If so, the next step, that is, sub-step s12, may be performed directly. If not, a root storage tree node is generated to create a storage tree for saving comment data of a user.

Sub-step s12, generating a storage tree node in the storage tree according to the comment data;

Practically, the comment data of a user may be one piece of comment data of the media data, or may be comment data in reply to a certain comment. Depending on the location of the comment data, it is determined whether to create a new storage tree node under the storage tree, or to create, under a certain storage tree node, its child storage tree node.

Sub-step s13, storing the comment data and the user identifier in the storage tree node;

In a preferred embodiment of the present application, the sub-step s13 may include the following sub-steps:

Sub-step s13-1, determining node location information of the storage tree node in the storage tree, and an associated storage tree node of the storage tree node in the storage tree; and

Sub-step s13-2, storing the comment data, the user identifier and the node location information in a storage tree node.

Specifically, the comment data will be stored in the newly created storage tree node. Of course, data other than the comment data can also be stored in the storage tree node. For example, the node location information of the storage tree node where the comment data is located in the storage tree, associated storage tree nodes of the storage tree node in the storage tree, as well as the user identifier, creation time, etc., are collectively stored in the storage tree node.

Sub-step s14, generating storage tree node information according to the storage tree node.

When storing of the comment data in the storage tree is completed, the data in the storage tree node is extracted as the storage tree node information.

Step 203: storing the storage tree node information as a self-owned comment array object according to the user identifier.

In a preferred embodiment of the present application, the step 203 may include the following sub-steps:

Sub-step s21, filtering out the storage tree node information corresponding to the user identifier, the storage tree node information comprises self-owned comment data;

Sub-step s22, determining the self-owned comment array object using the user identifier;

Sub-step s23, storing the storage tree node information in the self-owned comment array object.

In an embodiment of the present application, the storage tree node information may be stored in the corresponding self-owned comment array object according to the user identifier, as the user's self-owned comment data.

Specifically, first, the storage tree node information corresponding to a certain user is determined according to the user identifier, wherein the user's self-owned comment data is included in the storage tree node information. Further, the self-owned comment array object correspondingly maintained for a certain user is determined according to the user identifier, and the filtered storage tree node information is stored in the self-owned comment array object.

When a user wants to view his or her self-owned comment data, he or she can directly obtain his or her self-owned comment data in his or her self-owned comment array object. Since the self-owned comment array object is maintained for a certain user, whenever the user makes comments on the article, the comments are saved to the storage tree and updated to the self-owned comment array object according to the storage tree, therefore, when the user wants to view the self-owned comment data, the loading speed is very fast.

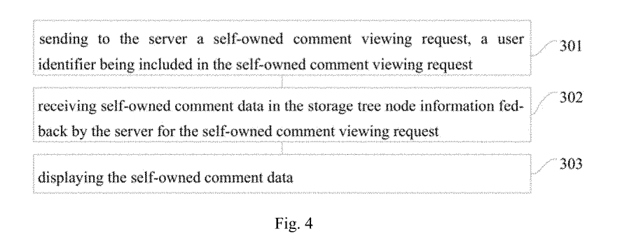

Referring to FIG. 4, a flow chart of steps of a method for displaying comment data of a user of the present application is shown, where the comment data includes self-owned comment data, and the method may include the following steps:

Step 301: sending to the server a self-owned comment viewing request, a user identifier being included in the self-owned comment viewing request.

In an embodiment of the present application, the user can click on a button or component on the client to generate a self-owned comment request and send it to the server, and request the server to feedback the comment data of the user under the media data, that is, self-owned comment data.

Step 302: receiving self-owned comment data in the storage tree node information fed-back by the server for the self-owned comment viewing request; wherein the user identifier has an associated self-owned comment array object, the self-owned comment array object comprises storage tree node information, and the self-owned comment data is stored in the storage tree node information;

The server receives the self-owned comment viewing request, and obtains the associated self-owned comment array object according to the user identifier carried by the self-owned comment viewing request, and feeds back the self-owned comment array object to the client, so that the user of the client can obtain the storage tree node information in the self-owned comment array object, which information contains the self-owned comment data.

Step 303, displaying the self-owned comment data.

In a preferred embodiment of the present application, the self-owned comment data includes a creation time, and the step 303 may include the following sub-steps:

Sub-step s31, obtaining a comment reply box template, the comment reply box template including a comment box;

Sub-step s32, adding the self-owned comment data to the comment box sequentially according to the creation time;

Sub-step s33, displaying the self-owned comment data based on the comment reply box template.

There are various ways to display the user's self-owned comment data on the client. For example, the “box” type may be used. That is, in a comment reply box template divided into multiple text boxes, self-owned comment data is placed respectively in the comment box. Here, the self-owned comment data can be ranked in reverse order according to the creation time.

Of course, the user's self-owned comment data may be displayed on the client in other ways, as long as the user's self-owned comment data is displayed in a clear hierarchy. This is not limited in embodiments of the present application.

In a preferred embodiment of the present application, the self-owned comment data is located under a certain media data, and the sub-step s32 may include the following sub-steps:

Sub-step s32-1, grouping the self-owned comment data according to the media data where it is located;

Sub-step s32-2, for the grouped self-owned comment data, adding the self-owned comment data of the same group to the comment box sequentially according to the creation time.

Practically, the user can make comments under one or more articles. Therefore, the self-comment data in embodiments of the present application can be further grouped according to the article where they are located, and can be ranked by group based on the grouping. For example, suppose that the user has recently made comments under the article a and the article b, wherein the last comment is on the article a, then the self-owned comment data under the article a and the article b are respectively grouped into a group, and the group of article a and the group of the article b are ranked, wherein the self-owned comment data of the article a is ranked first in the comment reply box template, even if other self-owned comment data under the article a is earlier than the self-owned comment data of the article b.

In a preferred embodiment of the present application, the self-owned comment data further comprises: a self-owned comment text, a total number of reply comment data for the self-owned comment data, a number of upvotes for the comment data, a number of downvotes for the self-owned comment data, whether the self-owned comment data is hot comment data.

In a preferred embodiment of the present application, the comment data further comprises associated comment data associated with the self-owned comment data, and the method may further include the following steps:

Sending an associated comment viewing request to the server, the associated comment viewing request including node location information of the self-owned comment data;

Receiving associated comment data of the associated storage tree node fed-back by the server for the associated comment viewing request; wherein the server is configured to determine the storage tree node of the self-owned comment data using the node location information, and obtain an associated storage tree node of the storage tree node in the storage tree; and

Displaying the associated comment data.

In the embodiment of the present application, if the user wants to view the associated comment data of a certain self-owned comment data, the user can click on the self-owned comment data, and the client will generate an associated comment viewing request that carries the node location information of the self-owned comment data, and sent it to the server.

After the server receives the associated comment viewing request, the server determines a storage tree node of the self-owned comment data according to the node location information, and obtains an associated storage tree node of the storage tree node in the storage tree, so as to obtain associated comment data of the associated storage tree node information in the associated storage tree node. Here, the storage tree node has a sibling node, a parent node, and a child node in the storage tree. In the embodiment of the present application, the sibling node, the parent node, and the child node of the storage tree node can be the associated storage tree node of the storage tree node. In addition, the comment data stored in the associated storage tree node will be the associated comment data of the self-owned comment data.

Since the manner of displaying the associated comment data is similar to the way in which the self-owned comment data is displayed, it is not described here.

The embodiments of the present application mainly include two parts: a storage structure based on the user's self-owned comment data, and a displaying operation. In order to enable those skilled in the art to better understand the embodiments of the present application, the following specific examples are used to describe the storing and displaying of the comment data of the present application.

The storage structure of the comment data of the embodiment of the present application may be a tree structure. When an article is replied (commented), a root storage tree node is created, and then all the comment data for the root storage tree node and the comment data for the comment data are extended downward in the way of a growing branch, where each node represents a reply, and the directed branches between nodes indicate the sequential order of the reply.

At the same time, a one-dimensional array of current user's self-owned comment data is maintained. Each array element of the array represents the current user's self-owned comment data. The order of the array represents the chronological order in which all of the user's self-owned comment data is created. The array element contains a pointer to a node in the comment storage tree. Quick access to a certain associated node of the comment storage tree can be made via the self-owned comment data. The nodes of the comment storage tree comprise information such as the number of times that the current comment data is replied, the number of upvotes and downvotes, and the time of creating or updating. Further, based on these data, the “heat” of the comment data and the like can be calculated.

In a specific implementation manner, the user may display the user's self-owned comment data in the form of a reply box in the client, and the displaying of the user reply box is ranked in reverse order by the time when the user's self-owned comment data is created. At the same time, the comment data can be grouped according to the article in which it is located, so that the user can see at a glance to which articles he or she has made comments. Meanwhile, other information can be added to the self-owned comment data, for example, whether there are new replies, the total number of replies, the number of upvotes and downvotes, whether it is popular or not. When the user clicks on a certain comment data, he or she will access to the previous or subsequent comment data of the current comment data, which can clearly show: to which article or comment data the current comment data is replying, and to which comments the downward extension based on the current comment data would reach. Preferably, the user can continue to expand or to perform commenting operation.

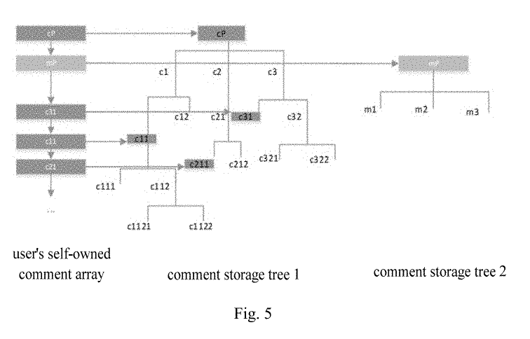

Referring to FIG. 5, a schematic diagram of a storage structure of a user comment data storage tree of the present application is shown, which includes a user's self-owned comment array (self-owned comment array object), an article C corresponds to the comment storage tree 1, and an article m corresponds to the comment storage tree 2.

The comment storage tree 1 contains all relevant comment data of the article C, where cP is a comment data under the article C, and c1, c2, c3 are three comment data that simultaneously replied to the CP comment data; c11, c12 are comment data that replied to c1; and cP, c31, c11, c211 are the user's own self-owned comment data, and so on. mP is the comment data of a user with respect to another article M, stored in another comment storage tree.

In the user's self-owned comment array, all of the user's self-owned comment data can be stored in chronological order. Each self-owned comment data has a pointer (node location information) pointing to a specific location in the comment storage tree, which can be used to quickly jump to the context location of the target comment data.

Specifically, the associated comment data of a certain self-owned comment data may be other comment data in the horizontal and vertical directions in the comment storage tree. A complete comment context is the entire tree branch where the target comment is located, and the sibling node of the same level of each node in the branch, up to only one level downwards from the current storage tree node. For example, the complete comment context for c11 node comments is: cP→c1, c2, c3→c12, c11→c111, c112. the entire sequence is ranked in the order in which each piece of comment data is created. It can be understood that the user is most concerned with the comment data related to his or her self-owned comments, that is, the user's self-owned comment data, which is included in the complete comment context of the current comment data. The nodes in each comment storage tree contain the text content of the comments themselves, the number of direct replies to comments, the number of upvotes and downvotes, and so on.

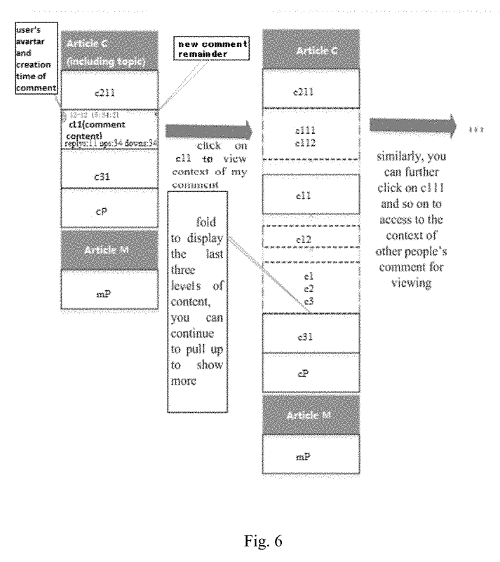

Referring to FIG. 6, a schematic diagram of a displaying operation of a comment data reply box of a user on a client of the present application is shown. When any user initiates a self-owned comment viewing request on the client, a storage tree node information fed-back by the server to the user is obtained. The client may extract the comment data from the storage tree node information, and the comment data may include only the user's self-owned comment data. The left side of the figure shows the comment reply box that is initially displayed, and may only display the user's self-owned comment data.

All the comment data can be grouped by the article on which the comment is made, and can be ranked by the creation time. For example, the comment data can be grouped by articles, and the article with the latest reply is nearer to the top. Under the same article, the latest posted comment data is the topmost one.

The comment data displayed in the reply box may include creation time, numbers of upvotes and downvotes for the comment, number of replies, reply reminder, etc. Of course, the comment data should contain the text content of the comment itself When the text box in the reply box is not enough to display a complete comment data, the first few characters intercepted from the comment data or several keywords extracted from the comment data may be displayed instead.

Of course, when implementing the embodiment of the present application, there are also other ways to display the user's comment data in the text boxes in the reply box, which is not limited in this embodiment of the present application.

When a comment data of a user is replied, or if the user wishes to see the details of the comment data, one can click on the comment data, such as c11. at this time, the position of c11 in the comment storage tree is found via the pointer in the self-owned comment array. Then, upward and downward traversal, or even traversal at the same level, may be performed using the node position information. The traversal operation can be performed between the nodes by using the doubly linked list, so that the full comment context of c11 is found quickly.

All comments in the full context of the comment may be arranged and displayed in the order they were created. If they are sibling comments in the same level, then they may be displayed in one dotted box, such as c111, c112 and c1, c2, c3. if they are not in one hierarchical level, then they may be displayed in two dotted boxes, such as c12 and c1. in this way, the user can understand very clearly: to which comment data he or she has replied to, and who has replied to his or her comment data. If the user is interested in the comment c111, then he or she can continue to click on c111, then the comment context of c111 is expanded upwards, and so on.

In summary, when the user of the embodiment of the present application makes comments on an article or replies to a certain comment, firstly, the corresponding comment storage tree is obtained based on the article to be replied, and then a target location is found in the comment storage tree, and a comment node is created and inserted into the tree, and then the pointer to the node is used for adding to the latest location of the user's self-owned comment list.

Applying the tree structure of comment storage in the embodiment of the present application may have the following advantages:

1. the comment data of a user for the article is stored based on the tree structure, which can preserve the hierarchical structure of the comments to the greatest extent, the original information of the comments will not be lost, and the comment data will not be stored repeatedly.

2. all the user's self-owned comment data can be quickly loaded and accessed without loading other irrelevant comment data, and the loading speed is fast. Ranking the comment data according to the tree structure can make the interface simple and concise with a clear hierarchy, and the user can know the comment hierarchy quickly.

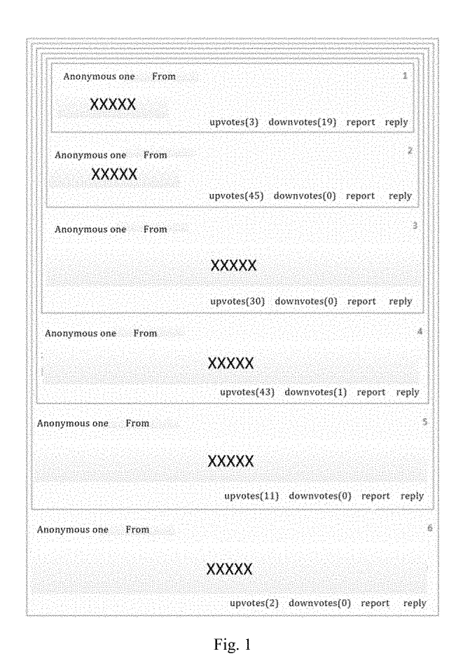

3. the user can select the comment data that is of interest to him/her; perform viewing of context comment and quick reply. The context can be obtained by traversing based on the pointer and the doubly linked list, the processing speed is very fast. Also, in the embodiment of the present application, it is possible to display only the user's designated contextual content of the comment without introducing other irrelevant comments, thereby enabling pinpointing of the user's requirements and quickly locating the user's needs. In this way, the page of the comment data displayed on the client will not be as messy as the prior art comment page with threads in FIG. 1.

Embodiments of the present application provide a storage policy structure based on the user's self-owned comment data, and provide, based on the structure, a method for displaying and operating of a user comment reply box. The storage structure applying the embodiment of the present application can efficiently store the user's self-owned comment data, as well as the context comment data of the self-owned comment data. The method for displaying and operating the reply box can clearly display all of the user's self-owned comment data, the context content of the self-owned comment data, and the hierarchical structure of the comment reply boxes, and at the same time, can enable the user to quickly access to the context of a hot comment reply box so as to perform in-depth viewing and operating. In the field of information flow commenting, the embodiments of the present application can greatly improve efficiency and user experience of the storing and displaying operations on self-owned comment data of a user.

It should be noted that, for method embodiments, for the sake of simple description, they are all expressed as a series of action combinations, but those skilled in the art should understand that the embodiments of the present application are not limited by the described sequential order of the actions. This is because, according to embodiments of the present application, certain steps may be performed in other sequential orders or be performed concurrently. Further, those skilled in the art should also understand that the embodiments described in the specification are all preferred embodiments, and the actions involved therein are not necessarily required in the embodiments of the present application.

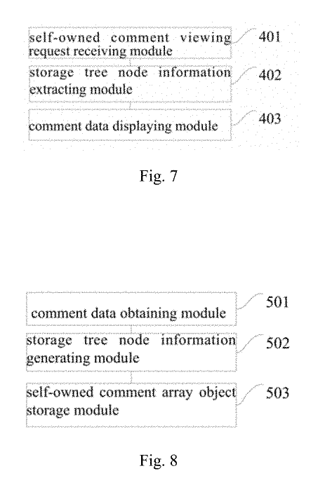

Referring to fig.7, a structural block diagram of a system for displaying comment data of a user of the present application is shown, wherein the user may have a user identifier, the comment data comprises self-owned comment data, the user identifier may have an associated self-owned comment array object, the self-owned comment array object may comprise storage tree node information, and the self-owned comment data may be stored in the storage tree node information,

The system may specifically comprise the following modules:

A self-owned comment viewing request receiving module 401, configured to receive a self-owned comment viewing request sent by a client, a user identifier being included in the self-owned comment viewing request;

A storage tree node information extracting module 402, configured to extract storage tree node information of a self-owned comment array object associated with the user identifier; and

A comment data displaying module 403, configured to feedback, to the client, the self-owned comment data in the storage tree node information, such that the self-owned comment data in the storage tree node information is displayed on the client.

In a preferred embodiment of the present application, the comment data further comprises associated comment data associated with the self-owned comment data, the storage tree node information may comprise node location information of a storage tree node of a storage tree where the self-owned comment data is located,

The system may further include:

An associated comment viewing request receiving module, configured to receive an associated comment viewing request sent by the client, the associated comment viewing request comprises the node location information of the self-owned comment data;

A storage tree node determining module, configured to determine a storage tree node of the self-owned comment data using the node location information;

An associated storage tree node obtaining module, configured to obtain an associated storage tree node of the storage tree node in a storage tree, the associated comment data being stored in the associated storage tree node; and

An associated comment data feedback module, configured to feedback to the client the associated comment data of the associated storage tree node.

In a preferred embodiment of the present application, the storage tree node may include associated node location information, and the associated storage tree node obtaining module may comprise:

An associated storage tree node determining submodule, configured to determine the associated storage tree node of the storage tree node in the storage tree using the associated node location information.

In a preferred embodiment of the present application, the comment data comprises: comment text, a total number of reply comment data for the comment data, a number of upvotes for the comment data, a number of downvotes for the comment data, whether the comment data is hot comment data, and creation time of the comment data.

Referring to fig.8, a structural block diagram of a system for displaying comment data of a user of the present application is shown. In particular, the system may comprise the following modules:

A comment data obtaining module 501, configured to obtain comment data of a user under media data, the comment data has a user identifier;

A storage tree node information generating module 502, configured to generate storage tree node information using the comment data and the user identifier; and

A self-owned comment array object storage module 503, configured to store the storage tree node information as a self-owned comment array object according to the user identifier.

In a preferred embodiment of the present application, the storage tree node information generating module 502 may include:

A storage tree determining submodule, configured to determine a storage tree corresponding to the media data;

A storage tree node generating submodule, configured to generate a storage tree node in the storage tree according to the comment data;

A comment data storage submodule, configured to store the comment data and the user identifier in the storage tree node;

A storage tree node information generating submodule, configured to generate storage tree node information according to the storage tree node.

In a preferred embodiment of the present application, the storage tree determining submodule comprises:

A storage tree determining unit, configured to determine whether there is a storage tree corresponding to the media data; if so, the storage tree node generating submodule is invoked, and if not, a storage tree creating unit is invoked; and

The storage tree creating unit, configured to create a root storage tree node to generate a storage tree.

In a preferred embodiment of the present application, the storage tree node information generating submodule may comprise:

A node location information determining unit, configured to determine node location information of the storage tree node in the storage tree, and an associated storage tree node of the storage tree node in the storage tree; and

A storage tree node information organizing unit, configured to store the comment data, the user identifier and the node location information in a storage tree node.

In a preferred embodiment of the present application, the self-owned comment array object storage module 503 may comprise:

A storage tree node information filtering submodule, configured to filter out the storage tree node information corresponding to the user identifier, the storage tree node information comprises self-owned comment data;

A self-owned comment array object determining submodule, configured to determine the self-owned comment array object using a user identifier of the storage tree node information; and

A storage tree node information storage submodule, configured to store the storage tree node information in the self-owned comment array object.

In a preferred embodiment of the present application, the self-owned comment data in the storage tree node information includes a creation time, and the storage tree node information storage submodule comprises:

A storage tree node information storage unit, configured to store the storage tree node information in the self-owned comment array object sequentially according to the creation time.

In the embodiment of the present application, storage tree node information will be generated in sequential order using the user's comment data under media data. Meanwhile, the storage tree node information is also used to maintain self-owned comment array object of the corresponding user according to the user identifier. Such storage tree structure can have the user's comment data saved in a clear hierarchy, so that the user can find the desired comment data efficiently, completely, flexibly and hierarchically.

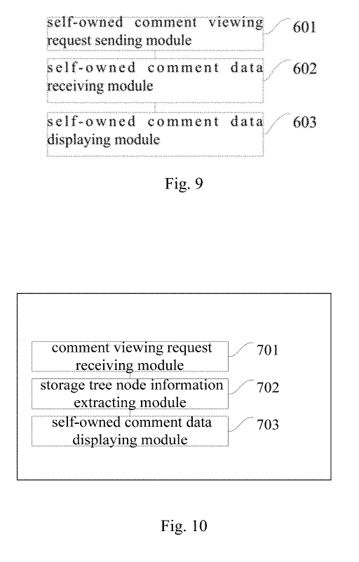

Referring to FIG. 9, a structural block diagram of a system for displaying comment data of a user of the present application is shown. The comment data comprises self-owned comment data, and the system may specifically comprise the following modules:

A self-owned comment viewing request sending module 601, configured to send a self-owned comment viewing request to a server, a user identifier being included in the self-owned comment viewing request;

A self-owned comment data receiving module 602, configured to receive self-owned comment data in the storage tree node information fed-back by the server for the self-owned comment viewing request; wherein the user identifier has an associated self-owned comment array object, the self-owned comment array object comprises storage tree node information, and the self-owned comment data is stored in the storage tree node information; and

A self-owned comment data displaying module 603, configured for displaying the self-owned comment data.

In a preferred embodiment of the present application, the self-owned comment data includes a creation time, and the self-owned comment data displaying module 603 comprises:

A comment reply box template obtaining submodule, configured to obtain a comment reply box template, the comment reply box template includes a comment box;

A self-owned comment data adding submodule, configured to add the self-owned comment data to the comment box sequentially according to the creation time;

A self-owned comment data template displaying submodule, configured to display the self-owned comment data based on the comment reply box template.

In a preferred embodiment of the present application, the self-owned comment data belongs to a certain media data, and the self-owned comment data adding submodule comprises:

A self-owned comment data grouping unit, configured to group the self-owned comment data according to the media data to which it belongs; and

A self-owned comment data adding-by-group unit configured to, for the grouped self-owned comment data, add the self-owned comment data of the same group to the comment box sequentially according to the creation time.

In a preferred embodiment of the present application, the comment data further comprises associated comment data associated with the self-owned comment data, the system further comprising:

An associated comment viewing request sending module, configured to send an associated comment viewing request to the server, the associated comment viewing request including node location information of the self-owned comment data;

An associated comment data receiving module, configured to receive associated comment data of the associated storage tree node fed-back by the server for the associated comment viewing request; wherein the server is configured to determine the storage tree node of the self-owned comment data using the node location information, and obtain an associated storage tree node of the storage tree node in the storage tree; and

An associated self-owned comment data displaying module, configured for displaying the associated comment data.

Referring to FIG. 10, a structural block diagram of an embodiment of means for displaying comment data of a user in a memory of a server of the present application, the user may have a user identifier, the comment data comprises self-owned comment data, the user identifier may have an associated self-owned comment array object, the self-owned comment array object may comprise storage tree node information, and the self-owned comment data may be stored in the storage tree node information,

The means for displaying comment data of a user may specifically comprise the following modules:

A self-owned comment viewing request receiving module 701, configured to receive a self-owned comment viewing request sent by a client, a user identifier being included in the self-owned comment viewing request;

A storage tree node information extracting module 702, configured to extract storage tree node information of a self-owned comment array object associated with the user identifier; and

A self-owned comment data displaying module 703, configured to feedback, to the client, the self-owned comment data in the storage tree node information, such that the self-owned comment data in the storage tree node information is displayed on the client.

In a preferred embodiment of the present application, the comment data further comprises associated comment data associated with the self-owned comment data, the storage tree node information may comprise node location information of a storage tree node of a storage tree where the self-owned comment data is located, the system may further comprise:

An associated comment viewing request receiving module, configured to receive an associated comment viewing request sent by the client, the associated comment viewing request comprises the node location information of the self-owned comment data;

A storage tree node determining module, configured to determine a storage tree node of the self-owned comment data using the node location information;

An associated storage tree node obtaining module, configured to obtain an associated storage tree node of the storage tree node in a storage tree, the associated comment data being stored in the associated storage tree node; and

An associated comment data feedback module, configured to feedback to the client the associated comment data of the associated storage tree node.

In a preferred embodiment of the present application, the storage tree node may include associated node location information, and the associated storage tree node obtaining module may include:

An associated storage tree node determining submodule, configured to determine the associated storage tree node of the storage tree node in the storage tree using the associated node location information.

In a preferred embodiment of the present application, the comment data comprises: a comment text, a total number of reply comment data for the self-owned comment data, a number of upvotes for the comment data, a number of downvotes for the self-owned comment data, whether the self-owned comment data is hot comment data, and a creation time of the comment data.

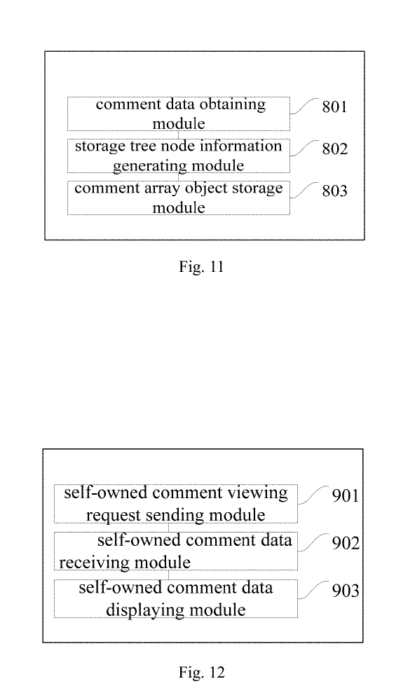

Referring to FIG. 11, a structural block diagram of means for storing comment data of a user in a memory of a server of the present application is shown. The means for storing comment data of a user may specifically include the following modules:

A comment data obtaining module 801, configured to obtain comment data of the user under media data, the comment data has a user identifier;

A storage tree node information generating module 802, configured to generate storage tree node information using the comment data and the user identifier;

A self-owned comment array object storage module 803, configured to store the storage tree node information as a self-owned comment array object according to the user identifier.

In a preferred embodiment of the present application, the storage tree node information generating module 802 may include:

A storage tree determining submodule, configured to determine a storage tree corresponding to the media data;

A storage tree node generating submodule, configured to generate a storage tree node in the storage tree according to the comment data;

A comment data storage submodule, configured to store the comment data and the user identifier in the storage tree node;

A storage tree node information generating submodule, configured to generate storage tree node information according to the storage tree node.

In a preferred embodiment of the present application, the storage tree determining submodule includes:

A storage tree determining unit, configured to determine whether there is a storage tree corresponding to the media data; if so, the storage tree node generating submodule is invoked, and if not, a storage tree creating unit is invoked; and

The storage tree creating unit, configured to create a root storage tree node to generate a storage tree.

In a preferred embodiment of the present application, the storage tree node information generating submodule may comprise:

A node location information determining unit, configured to determine node location information of the storage tree node in the storage tree, and an associated storage tree node of the storage tree node in the storage tree; and

A storage tree node information organizing unit, configured to store the comment data, the user identifier and the node location information in a storage tree node.

In a preferred embodiment of the present application, the self-owned comment array object storage module 803 may comprise:

A storage tree node information filtering submodule, configured to filter out the storage tree node information corresponding to the user identifier, the storage tree node information comprises self-owned comment data;

A self-owned comment array object determining submodule, configured to determine the self-owned comment array object using a user identifier of the storage tree node information; and

A storage tree node information storage submodule, configured to store the storage tree node information in the self-owned comment array object.

In a preferred embodiment of the present application, the self-owned comment data in the storage tree node information includes a creation time, and the storage tree node information storage submodule comprises:

A storage tree node information storage unit, configured to store the storage tree node information in the self-owned comment array object sequentially according to the creation time.

Referring to fig.12, a structural block diagram of means for displaying the comment data of the user in a memory of a user terminal of the present application is shown, the comment data comprises self-owned comment data, and the means for displaying the comment data of the user may specifically include the following modules:

A self-owned comment viewing request sending module 901, configured to send to the server a self-owned comment viewing request, a user identifier being included in the self-owned comment viewing request;

A self-owned comment data receiving module 902, configured to receive self-owned comment data in the storage tree node information fed-back by the server for the self-owned comment viewing request; wherein the user identifier has an associated self-owned comment array object, the self-owned comment array object comprises storage tree node information, and the self-owned comment data is stored in the storage tree node information; and

A self-owned comment displaying module 903, configured to display the self-owned comment data.

In a preferred embodiment of the present application, the self-owned comment data includes a creation time, and the self-owned comment data displaying module 903 includes:

A comment reply box template obtaining submodule, configured to obtain a comment reply box template, the comment reply box template includes a comment box;

A self-owned comment data adding submodule, configured to add the self-owned comment data to the comment box sequentially according to the creation time;

A self-owned comment data template displaying submodule, configured to display the self-owned comment data based on the comment reply box template.

In a preferred embodiment of the present application, the self-owned comment data belongs under a certain media data, and the self-owned comment data adding submodule comprises:

A self-owned comment data grouping unit, configured to group the self-owned comment data according to the media data to which it belongs; and

A self-owned comment data adding-by-group unit configured to, for the grouped self-owned comment data, add the self-owned comment data of the same group to the comment box sequentially according to the creation time.

In a preferred embodiment of the present application, the comment data further comprises associated comment data associated with the self-owned comment data, the system further comprising:

An associated comment viewing request sending module, configured to send an associated comment viewing request to the server, the associated comment viewing request including node location information of the self-owned comment data;

An associated comment data receiving module, configured to receive associated comment data of the associated storage tree node fed-back by the server for the associated comment viewing request; wherein the server is configured to determine the storage tree node of the self-owned comment data using the node location information, and obtain an associated storage tree node of the storage tree node in the storage tree; and

An associated self-owned comment data displaying module, configured for displaying the associated comment data.

For the system, the server and the client embodiments, since they are basically similar to the method embodiments, the description is relatively simple, and the description of the method embodiment can be referred to for the related parts.

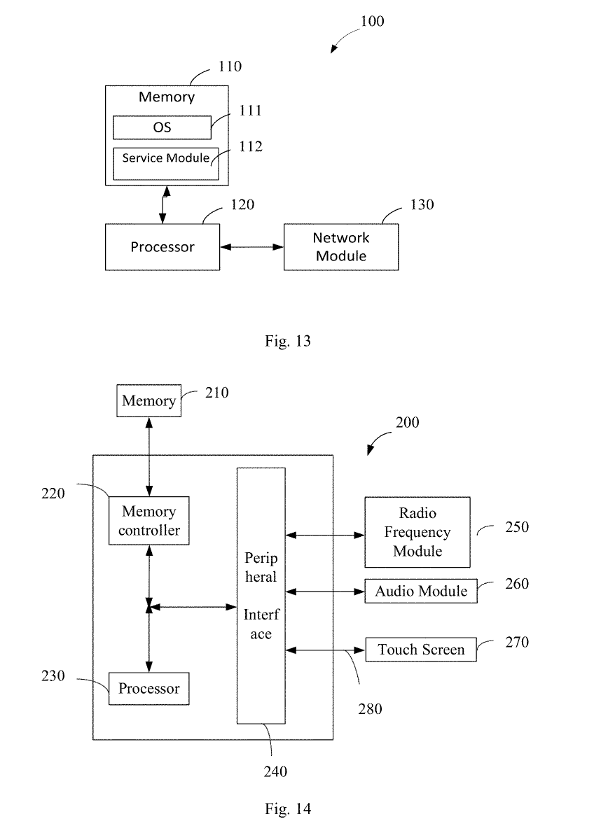

FIG. 13 shows a block diagram of the server. The server 100 includes a memory 110, a processor 120, and a network module 130.

The memory 110 can be used to store software programs and modules, such as programs and modules corresponding to the method and means for displaying comment data of a user, or method and means for storing comment data of a user in the embodiments of the present invention. Processor 120 performs various functional applications and data processing, i.e. To implement the method for displaying comment data of a user or the method for storing comment data of a user in the embodiments of the present invention, by executing the software programs and modules stored in the memory 110. memory 110 may include high speed random access memories, and may also include non-volatile memories such as one or more of magnetic storage devices, flash memory, or other non-volatile solid state memory. Further, the software programs and modules in the abovementioned memory 110 may also include an operating system 111 and a service module 112. the operating system 111, for example, may be linux, unix, windows, which may include various software components and/or drivers for managing system tasks (e.g., memory management, storage device control, power supply management, etc.), and may communicate with various hardware or software components to provide an operating environment for other software components. The service module 112 runs on the basis of the operating system 111, and listens for requests from the network through the network service of the operating system 111, completes corresponding data processing according to the request, and returns the processing result to the client. That is, the service module 112 is configured to provide network services to clients.

The network module 130 is configured to receive and transmit network signals. The abovementioned network signal may include a wireless signal or a wired signal.

It will be understood that the structure shown in FIG. 13 is merely illustrative, and the server 100 may further include more or less components than those shown in FIG. 13, or have a different configuration from that shown in FIG. 13. the components shown in FIG. 13 can be implemented in hardware, software, or a combination thereof.

FIG. 14 is a structural block diagram of a user terminal 200 according to an embodiment of the present invention. As shown in FIG. 14, the user terminal 200 includes a memory 210, a memory controller 220, one or more (only one is shown in the figure) processors 230, a peripheral interface 240, a radio frequency module 250, an audio module 260, a touch screen 270, and so on. These components communicate with one another via one or more communication bus/signal lines 280.

The memory 210 can be used to store software programs and modules, such as programs and modules corresponding to the method and means for displaying comment data of a user in the embodiments of the present invention. Processor 230 performs various functional applications and data processing, e.g. The method for displaying comment data of a user provided by the embodiments of the present invention, by executing the software programs and modules stored in the memory 210.

Memory 210 may include high speed random access memories and may also include non-volatile memories such as one or more magnetic storage devices, flash memory, or other non-volatile solid state memory. Access to the memory 210 by the processor 230 and other possible components can be performed under the control of the memory controller 220.

A peripheral interface 240 couples various input/output devices to processor 230 and memory 210. in some embodiments, the peripheral interface 240, the processor 230, and the memory controller 220 can be implemented in a single chip. In other instances, they can be implemented by separate chips.

The radio frequency module 250 is configured to receive and transmit electromagnetic waves, and realize mutual conversion between electromagnetic waves and electric signals, thereby communicating with a communication network or other devices.

The audio module 260 provides an audio interface to the user, which may include one or more microphones, one or more speakers and audio circuitry.

Touch screen 270 provides an output and input interface simultaneously between computer device 200 and the user. Specifically, the touch screen 270 displays video output to the user, and the content of the video output may include text, graphics, video, and any combination thereof.

It will be understood that the structure shown in FIG. 14 is merely illustrative, and the user terminal 200 may further include more or less components than those shown in FIG. 14, or have a different configuration from that shown in FIG. 14. the components shown in FIG. 14 can be implemented in hardware, software, or a combination thereof.

The various embodiments in the present specification are described in a progressive manner, and each embodiment focuses on differences from other embodiments, and the same or similar parts between the various embodiments can be referred to each other.

Those skilled in the art will appreciate that embodiments of the embodiments of the present application can be provided as a method, an apparatus, or a computer program product. Therefore, the embodiments of the present application may take the form of a full hardware embodiment, a full software embodiment, or an embodiment combining software and hardware. Moreover, embodiments of the present application can take the form of a computer program product embodied on one or more computer-usable non-volatile storage media having computer usable program code included therein (including but not limited to magnetic disks, cd-rom, optical storage, etc.).

In a typical configuration, the computer device includes one or more processors (CPUs), input/output interfaces, network interfaces, and a memory. The memory may include forms of a computer readable medium such as a non-persistent memory, a random access memory (RAM), and/or a non-volatile memory, such as read only memory (ROM) or flash memory. The memory is an example of a computer readable medium. Computer readable media include permanent and non-permanent, removable and non-removable media, and can realize information storage by any method or technology. The information can be computer readable instructions, data structures, modules of programs, or other data. Examples of non-volatile storage media for a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital versatile disk (DVD) or other optical storages, magnetic tape cartridges, magnetic tape storage or other magnetic storage devices or any other non-transporting media that may be used to store information that can be accessed by the computing device. As defined herein, a computer non-volatile readable medium does not include computer readable transitory media, such as modulated data signals and carrier waves.

Embodiments of the present application are described with reference to flowcharts and/or block diagrams of methods, terminal devices (systems), and computer program products according to embodiments of the present application. It will be understood that each flows and/or blocks of the flowchart illustrations and/or block diagrams, and combinations of flows and/or blocks of the flowchart illustrations and/or block figures, may be implemented by computer program instructions. The computer program instructions can be provided to a processor of a general purpose computer, a special purpose computer, an embedded processor or other programmable data processing terminal device to produce a machine, such that instructions that are executed by a processor of a computer or other programmable data processing terminal device generate means for implementing the functions specified in one or more flows in a flowchart illustration and/or one or more blocks of in a block diagram.

The computer program instructions can also be stored in a computer readable memory that can direct a computer or other programmable data processing terminal device to operate in a particular manner, such that instructions stored in the computer readable memory produce an article of manufacture comprising the instruction means. The instruction means implements the functions specified in one or more flows in a flowchart illustration and/or one or more blocks of in a block diagram.

These computer program instructions can also be loaded onto a computer or other programmable data processing terminal device such that a series of operational steps are performed on the computer or other programmable terminal device to produce computer-implemented processing, such that the instructions executed on a computer or other programmable terminal device provide steps for implement the functions specified in one or more flows in a flowchart illustration and/or one or more blocks of in a block diagram. While preferred embodiments among the embodiments of the present invention have been described, those skilled in the art can make additional changes and modifications to the embodiments once they know the basic inventive concepts. Therefore, the appended claims are intended to be interpreted as including all the modifications and modifications that fall into the range of the embodiments of the present application. Finally, it should also be noted that in this context, relational terms such as “first” and “second” are used merely to distinguish one entity or operation from another entity or operation, and do not necessarily require or imply any such actual relationship or order exist between these entities or operations. Furthermore, the terms “comprise”, “include” or other variations intend to cover non-excluding inclusions, and also include other elements not expressly listed, or elements inherent to such a process, method, article, or terminal device. An element defined by the phrase “comprising a . . . ” does not exclude the presence of additional identical elements in a process, method, article, or terminal device that includes the element, without further limitation. The above has described in detail about a method for storing comment data of a user, a method for storing comment data of a user, a system for storing comment data of a user, and a system for processing comment data of a user, a server and a user terminal. Although detailed description is given herein. Although the principles and embodiments of the present application have been described with reference to specific examples herein, the description of the above embodiments is only to assist in understanding the method of the present application and its essential ideas. At the same time, those skilled in the art may make changes to the specific embodiments and the scope of application according to the idea of the present application. In conclusion, the content of the present specification should not be construed as limiting the present application.

1. A method for displaying comment data of a user, wherein the user has a user identifier, the comment data comprises self-owned comment data, and the user identifier has an associated self-owned comment array object, wherein the self-owned comment array object comprises storage tree node information and the self-owned comment data is stored in the storage tree node information, the method comprising:
receiving a self-owned comment viewing request sent by a client, a user identifier being included in the self-owned comment viewing request;
extracting storage tree node information of a self-owned comment array object associated with the user identifier; and
feeding back to the client the self-owned comment data in the storage tree node information, such that the self-owned comment data in the storage tree node information is displayed on the client.

2. The method of claim 1, wherein the comment data further comprises associated comment data associated with the self-owned comment data, and wherein the storage tree node information comprises node location information corresponding to a storage tree node of a storage tree where the self-owned comment data is located,
the method further comprising:
after the step of feeding back to the client the self-owned comment data in the storage tree node information such that the self-owned comment data in the storage tree node information is displayed on the client, receiving an associated comment viewing request sent by the client, the associated comment viewing request comprises the node location information of the self-owned comment data;
determining a storage tree node of the self-owned comment data using the node location information;
obtaining an associated storage tree node of the storage tree node in a storage tree, the associated comment data being stored in the associated storage tree node; and
feeding back to the client the associated comment data of the associated storage tree node.

3. The method of claim 2, wherein the storage tree node includes associated node location information, and wherein the step of obtaining an associated storage tree node of the storage tree node in the storage tree comprises:
determining the associated storage tree node of the storage tree node in the storage tree using the associated node location information.

4. The method of claim 1, wherein the comment data comprises: comment text, a total number of reply comment data for the comment data, a number of upvotes for the comment data, a number of downvotes for the comment data, whether the comment data is hot comment data, and creation time of the comment data.

5. A method for storing comment data of a user, comprising:
obtaining comment data of a user under media data, wherein the comment data has a user identifier;
generating storage tree node information using the comment data and the user identifier; and
storing the storage tree node information as a self-owned comment array object according to the user identifier.

6. The method of claim 5, wherein the step of generating storage tree node information using the comment data and the user identifier comprises:
determining a storage tree corresponding to the media data;
generating a storage tree node in the storage tree according to the comment data;
storing the comment data and the user identifier in the storage tree node; and
generating storage tree node information according to the storage tree node.

7. The method of claim 6, wherein the step of determining a storage tree corresponding to the media data comprises:
determining whether there is a storage tree corresponding to the media data;
if yes, performing the step of generating a storage tree node in the storage tree according to the comment data; and
if not, creating a root storage tree node to generate a storage tree.

8. The method of claim 6, wherein the step of generating storage tree node information according to the storage tree node comprises:
determining node location information of the storage tree node in the storage tree and an associated storage tree node of the storage tree node in the storage tree; and
storing the comment data, the user identifier, and the node location information in a storage tree node.

9. The method of claim 5, wherein the comment data comprises self-owned comment data, and the step of storing the storage tree node information as a self-owned comment array object according to the user identifier comprises:
filtering out the storage tree node information corresponding to the user identifier, wherein the storage tree node information comprises self-owned comment data;
determining the self-owned comment array object using the user identifier; and
storing the storage tree node information in the self-owned comment array object.

10. The method of claim 9, wherein the self-owned comment data in the storage tree node information includes a creation time, and the step of storing the storage tree node information in the self-owned comment array object comprises:
storing the storage tree node information in the self-owned comment array object sequentially according to the creation time.

11. A system for displaying comment data of a user, wherein the user has a user identifier, the comment data comprises self-owned comment data, and the user identifier has an associated self-owned comment array object, wherein the self-owned comment array object comprises storage tree node information and the self-owned comment data is stored in the storage tree node information, the system comprising:
a self-owned comment viewing request receiving module device configured to receive a self-owned comment viewing request sent by a client, a user identifier being included in the self-owned comment viewing request;
a storage tree node information extracting module device configured to extract storage tree node information of a self-owned comment array object associated with the user identifier; and
a comment data displaying module device configured to feedback to the client the self-owned comment data in the storage tree node information such that the self-owned comment data in the storage tree node information is displayed on the client.

12. The system of claim 11, wherein the comment data further comprises associated comment data associated with the self-owned comment data, and wherein the storage tree node information comprises node location information corresponding to a storage tree node of a storage tree where the self-owned comment data is located,
the system further comprising:
an associated comment viewing request receiving device configured to receive an associated comment viewing request sent by the client, wherein the associated comment viewing request comprises the node location information of the self-owned comment data;
a storage tree node determining device configured to determine a storage tree node of the self-owned comment data using the node location information;
an associated storage tree node obtaining module device configured to obtain an associated storage tree node of the storage tree node in a storage tree, the associated comment data being stored in the associated storage tree node; and
an associated comment data feedback device configured to feedback to the client the associated comment data of the associated storage tree node.

13. The system of claim 12, wherein the storage tree node includes associated node location information, and wherein the associated storage tree node obtaining module comprises:
an associated storage tree node determining processor configured to determine the associated storage tree node of the storage tree node in the storage tree using the associated node location information.

14. A system for storing comment data of a user, comprising:
a comment data obtaining device, configured to obtain self-owned comment data of a user under media data, wherein the comment data has a user identifier;
a storage tree node information generating device, configured to generate storage tree node information using the comment data and the user identifier; and
a self-owned comment array object storage device, configured to store the storage tree node information as a self-owned comment array object according to the user identifier.

15. The system of claim 14, wherein the storage tree node information generating device comprises:
a storage tree determining processor configured to determine a storage tree corresponding to the media data;
a storage tree node generating processor configured to generate a storage tree node in the storage tree according to the comment data;
a comment data storage processor configured to store the comment data and the user identifier in the storage tree node; and
a storage tree node information generating processor configured to generate storage tree node information according to the storage tree node.

16. The system of claim 15, wherein the storage tree determining processor comprises:
a storage tree determining circuit, configured to determine whether there is a storage tree corresponding to the media data; if so, the storage tree node generating device is invoked, and if not, a storage tree creating circuit is invoked; and
the storage tree creating circuit, configured to create a root storage tree node to generate a storage tree.

17. The system of claim 15, wherein the storage tree node information generating processor comprises:
a node location information determining circuit, configured to determine node location information of the storage tree node in the storage tree and an associated storage tree node of the storage tree node in the storage tree; and
a storage tree node information organizing circuit, configured to store the comment data, the user identifier and the node location information in a storage tree node.

18. The system of claim 14, wherein the self-owned comment array object storage device comprises:
a storage tree node information filtering processor configured to filter out the storage tree node information corresponding to the user identifier, wherein the storage tree node information comprises self-owned comment data;
a self-owned comment array object determining processor configured to determine the self-owned comment array object using a user identifier of the storage tree node information; and
a storage tree node information storage processor configured to store the storage tree node information in the self-owned comment array object.

19. The system of claim 18, wherein the self-owned comment data in the storage tree node information includes a creation time, and wherein the storage tree node information storage processor comprises:
a storage tree node information storage circuit configured to store the storage tree node information in the self-owned comment array object sequentially according to the creation time.

20.-21. (canceled)

22. A method for displaying comment data of a user, wherein the comment data comprises self-owned comment data, the method comprising:
sending to the server a self-owned comment viewing request, a user identifier being included in the self-owned comment viewing request;
receiving self-owned comment data in the storage tree node information fed-back by the server for the self-owned comment viewing request; wherein the user identifier has an associated self-owned comment array object, the self-owned comment array object comprises storage tree node information, and the self-owned comment data is stored in the storage tree node information; and
displaying the self-owned comment data.

23. The method of claim 22, wherein the self-owned comment data includes a creation time, and wherein the step of displaying the self-owned comment data comprises:
obtaining a comment reply box template, the comment reply box template including a comment box;
adding the self-owned comment data to the comment box sequentially according to the creation time; and
displaying the self-owned comment data based on the comment reply box template.

24. The method of claim 23, wherein the self-owned comment data is located under a certain media data, and wherein the step of adding the self-owned comment data to the comment box sequentially according to the creation time comprises:
grouping the self-owned comment data according to the media data where it is located; and
for the grouped self-owned comment data, adding the self-owned comment data of the same group to the comment box sequentially according to the creation time.

25. The method of claim 23, wherein the self-owned comment data further comprises: a self-owned comment text, a total number of reply comment data for the self-owned comment data, a number of upvotes for the comment data, a number of downvotes for the self-owned comment data, whether the self-owned comment data is hot comment data.

26. The method of claim 22, wherein the comment data further comprises associated comment data associated with the self-owned comment data, the method further comprising:
sending an associated comment viewing request to the server, the associated comment viewing request including node location information of the self-owned comment data;
receiving associated comment data of the associated storage tree node fed-back by the server for the associated comment viewing request; wherein the server is configured to determine the storage tree node of the self-owned comment data using the node location information, and obtain an associated storage tree node of the storage tree node in the storage tree; and
displaying the associated comment data.

27. The method of claim 26, wherein the storage tree node has a sibling node, a parent node and a child node in the storage tree, and wherein the sibling node, the parent node and the child node are associated storage nodes of the storage tree.

28.-32. (canceled)
